(19) United States
(12) Patent Application Publication
(10) Pub. No.: US 2025/0028569 A1
(43) Pub. Date: Jan. 23, 2025

(54) METHODS, SYSTEMS, AND COMPUTER READABLE MEDIA FOR PROVIDING AND USING SHUFFLE TEMPLATES TO DISTRIBUTE DATA AMONG WORKERS COMPRISING COMPUTE RESOURCES IN A DATA CENTER

(71) Applicants: The Trustees of the University of Pennsylvania, Philadelphia, PA (US); William Marsh Rice University, Houston, TX (US)

(72) Inventors: Boon Thau Loo, Cherry Hill, NJ (US); Vincent Fu-dung Liu, Philadelphia, PA (US); Ang Chen, Pearland, TX (US); Qizhen Zhang, Redmond, WA (US); Jiacheng Wu, Seattle, WA (US)

(21) Appl. No.: 18/778,478

(22) Filed: Jul. 19, 2024

Related U.S. Application Data
(60) Provisional application No. 63/528,011, filed on Jul. 20, 2023.

(51) Int. Cl. G06F 9/50

(52) U.S. Cl. CPC G06F 9/505

(57) ABSTRACT

A method for providing shuffle templates and using the shuffle templates to implement shuffling of data among workers comprising compute resources in a data center includes providing, by a shuffle manager, an application programming interface (API) through which applications can select shuffle templates and specify data to be processed by the workers in the data center using the shuffle templates to distribute the data as messages transmitted among the workers. The shuffle manager receives a call for a shuffle template including a shuffle template identifier source and destination identifiers for processing by the workers. The shuffle manager selects the shuffle template identified by the call for the shuffle template and provides the shuffle template to the workers. Workers use the shuffle template to generate a shuffle plan and use the shuffle plan to shuffle the messages among the workers between the sources and the destinations.

### CROSS-REFERENCE TO RELATED APPLICATIONS

This application claims the benefit of U.S. Provisional Patent Application Ser. No. 63/528,011, filed Jul. 20, 2023, the disclosure of which is incorporated herein by reference in its entirety.

### STATEMENT OF GOVERNMENT INTEREST

This invention was made with government support under 2107147, 2104882, 2106388, and 1845749 awarded by the National Science Foundation. The government has certain rights in the invention.

### TECHNICAL FIELD

The subject matter described herein relates to data distribution in a data center. More specifically, the subject matter relates to methods, systems, and computer readable media for providing and using shuffle templates to distribute data among workers comprising compute resources in a data center.

### BACKGROUND

Large-scale data analytics systems are a key application class in modern data centers. Universal to these platforms is the need to transfer data between blocks of compute. Processing typically occurs in a few key phases: (i) compute, in which workers independently process their local shard of data, (ii) combine, an optional step, in which preliminary results are locally processed to reduce the data that passes through, and (iii) shuffle, the process of resharding and transmitting data to the next phase of compute. FIG. 1 shows a prior art structure of a data analytics system including computation, combination, and shuffling phases. This process can be applied to various systems like MapReduce, graph processing, and cloud-based analytics systems.

Of particular note in this pipeline is the shuffle phase. Compression, serialization, message processing, and transmission all contribute to the CPU, bandwidth, and latency overhead of this phase. More so than the other two phases, shuffles, if planned poorly, can become a significant throughput and latency bottleneck of the system. Application performance is often gated on tail completion time of the shuffle. Shuffle can be a major performance bottleneck in data analytics on emerging cloud platforms.

Tuning the behavior of the shuffle phase is non-trivial as performance characteristics are not only highly dependent on the workloads, but also on the underlying data center architecture. Also, more and more big data systems opt for disaggregated in-memory and virtual disk storage that cross a network where interactions are complex, the topology is constantly changing due to failures, and next-generation designs are increasingly sophisticated. There is a need for a shuffle that can adapt to application data and data center infrastructure for implementation on current and evolving systems.

### SUMMARY

The subject matter relates to methods, systems, and computer readable media for providing shuffle templates and using the shuffle templates to implement shuffling of data among workers comprising compute resources in a data center. An example method for providing shuffle templates and using the shuffle templates to implement shuffling of data among workers comprising compute resources in a data center includes providing, by a shuffle manager, an application programming interface (API) through which applications can select shuffle templates and specify data to be processed by the workers in the data center using the shuffle templates to distribute the data as messages transmitted among the workers. The method further includes receiving, by the shuffle manager and via the API, a call for a shuffle template, the call including a shuffle template identifier for one of the shuffle templates and source and destination identifiers respectively identifying sources and destinations of data to be processed by the workers. The method further includes selecting, by the shuffle manager, the shuffle template identified by the call for the shuffle template. The method further includes providing, by the shuffle manager, the shuffle template to the workers. The method further includes at the workers, using the shuffle template to generate a shuffle plan and using the shuffle plan to shuffle the messages among the workers between the sources and the destinations.

According to another aspect of the method described herein, providing the API includes providing a shuffle call API through which applications can specify a worker identifier, a template identifier, the shuffle template identifier, a shuffle invocation identifier, the source and destination identifiers, and buffers for sent or received data.

According to another aspect of the method described herein, the shuffle template includes parameters for the workers to process and transfer the data.

According to another aspect of the method described herein, the parameters define shuffle operations to perform on the data.

According to another aspect of the method described herein, the parameters include a send parameter for sending a message to a destination, a receive parameter for returning data received from a source, and a fetch parameter for returning data fetched from a source.

According to another aspect of the method described herein, the parameters include a partition parameter for partitioning messages according to a partition function and a combine parameter for combining message according to a combination function.

According to another aspect of the method described herein, the parameters include a sample function for sampling messages based on a rate and partition function.

According to another aspect of the subject matter described herein, the method further includes using the sample function to perform partition-aware sampling of the messages processed by different groups of workers in the data center.

According to another aspect of the subject matter described herein, the method further includes using results of the sampling to evaluate shuffle performance.

According to another aspect of the method described herein, the call for the shuffle template comprises a remote procedure call (RPC).

According to another aspect of the method described herein, the shuffle template is configured to control the workers to shuffle the messages at a server level, then at a rack level, and a global level.

An example system for providing shuffle templates and using the shuffle templates to implement shuffling of data among workers comprising compute resources in a data center includes a shuffle manager configured for providing an application programming interface (API) through which applications can select shuffle templates and specify data to be processed by the workers in the data center using the shuffle templates to distribute the data as messages transmitted among the workers. The shuffle manager is further configured for receiving, via the API, a call for a shuffle template, the call including a shuffle template identifier for one of the shuffle templates and source and destination identifiers respectively identifying sources and destinations of data to be processed by the workers. The shuffle manager is further configured for selecting the shuffle template identified by the call for the shuffle template. The shuffle manager is further configured for providing the shuffle template to the workers. The system further includes workers configured for using the shuffle template to generate a shuffle plan and using the shuffle plan to shuffle the messages among the workers between the sources and the destinations.

According to another aspect of the system described herein, the API includes a shuffle call API through which applications can specify a worker identifier, a template identifier, the shuffle template identifier, a shuffle invocation identifier, the source and destination identifiers, and buffers for sent or received data.

According to another aspect of the system described herein, the shuffle template includes parameters for the workers to process and transfer the data.

According to another aspect of the system described herein, the parameters define shuffle operations to perform on the data.

According to another aspect of the system described herein, the parameters include a send parameter for sending a message to a destination, a receive parameter for returning data received from a source, and a fetch parameter for returning data fetched from a source.

According to another aspect of the system described herein, the parameters include a partition parameter for partitioning messages according to a partition function and a combine parameter for combining message according to a combination function.

According to another aspect of the system described herein, the parameters include a sample function for sampling messages based on a rate and partition function.

According to another aspect of the system described herein, the workers are configured for using the sample function to perform partition-aware sampling of the messages processed by different groups of workers in the data center.

According to another aspect of the system described herein, the workers are configured for using results of the sampling to evaluate shuffle performance.

According to another aspect of the system described herein, the call for the shuffle template comprises a remote procedure call (RPC).

According to another aspect of the system described herein, the shuffle template is configured to control the workers to shuffle the messages at a server level, then at a rack level, and a global level.

An example non-transitory computer readable medium has stored thereon executable instructions that when executed by at least one processor of at least one computer cause the at least one computer to perform steps comprising providing an application programming interface (API) through which applications can select shuffle templates and specify data to be processed by workers in a data center using the shuffle templates to distribute the data as messages transmitted among the workers. The steps further include receiving, via the API, a call for a shuffle template, the call including a shuffle template identifier for one of the shuffle templates and source and destination identifiers respectively identifying sources and destinations of data to be processed by the workers. The steps further include selecting the shuffle template identified by the call for the shuffle template. The steps further include providing the shuffle template to the workers. The steps further include using the shuffle template to generate a shuffle plan and using the shuffle plan to shuffle the messages among the workers between the sources and the destinations.

According to another aspect of the non-transitory computer readable medium described herein, providing the API includes providing a shuffle call API through which applications can specify a worker identifier, a template identifier, the shuffle template identifier, a shuffle invocation identifier, the source and destination identifiers, and buffers for sent or received data.

The subject matter described herein may be implemented in hardware, software, firmware, or any combination thereof. As such, the terms “function” or “node” as used herein refer to hardware, which may also include software and/or firmware components, for implementing the feature(s) being described. In some exemplary implementations, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The subject matter described herein will now be explained with reference to the accompanying drawings of which:

FIG. 1 shows a prior art structure of a data analytics system;

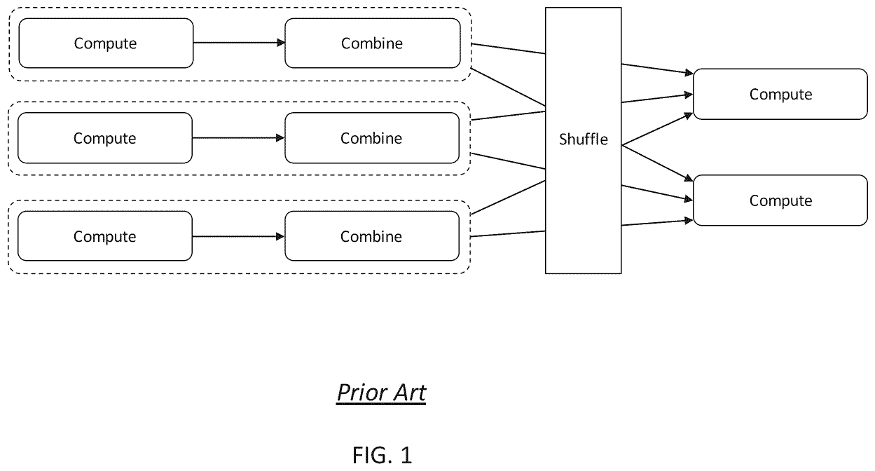

FIG. 2 is a block diagram of an example system for providing shuffle templates and using the shuffle templates to implement shuffling of data among workers comprising compute resources in a data center;

FIG. 3 is a table of parameters to a shuffle call;

FIG. 4 is a table listing shuffle template parameters that are automatically instantiated when a shuffle template is received by workers;

FIG. 5 is a table listing examples of shuffling algorithms and optimizations;

FIG. 6 shows an example network-aware shuffling template;

FIG. 7 shows a block diagram representing a partition-aware sampling;

FIG. 8 shows a chart comparing the effectiveness of random sampling and partition-aware sampling;

FIG. 9 shows the tradeoff between sampling accuracy and overhead for partition-aware sampling;

FIG. 10 is a table showing evaluations of oversubscription ratios; and

FIG. 11 is a flow diagram of an example method for providing shuffle templates and using the shuffle templates to implement shuffling of data among workers comprising compute resources in a data center.

### DETAILED DESCRIPTION

The subject matter described herein relates to methods, systems, and computer readable media for providing shuffle templates and using the shuffle templates to implement shuffling of data among workers comprising compute resources in a data center. The system provides shuffle templates, specifically parameterized shuffle templates. The templates are instantiated by accurate and efficient sampling for dynamic adaptation to different application workloads and data center infrastructure, which enables shuffling optimizations that improve performance and adapt to a variety of data center network scenarios.

The system implements parameterized shuffle templates, which provide a set of shuffle primitives that can greatly simplify the job of writing performant data analytics software. The system can utilize a wide array of shuffle templates. Shuffle templates can leave various parameters undefined for tailoring to specific infrastructures or workloads. At runtime, The system instantiates the shuffle template by populating the parameters using knowledge of the underlying topology and data achieved via sampling. The system enables infrastructure-aware optimizations that provide the illusion of hand-tuned performance, but in a portable fashion where a programmer could deploy graph systems, e.g., Pregel or Spark jobs, without worrying about how shuffling (and hence overall performance) is impacted by the workload characteristics, network topologies, and failure scenarios.

The system is configured for utilizing a customizable shuffle with template. The shuffle templates are expressive enough to support a wide range of big data analytics system and shuffle optimization. The system provide network-aware shuffle by instantiating shuffle templates at runtime. In particular, the system provides an adaptive optimization that dynamically chooses the best shuffling strategy for a given data center network topology. The system can enable adaptive optimizations that significantly improve application performance. The system can implement sampling based-parameter tuning to achieve high accuracy with low sampling cost.

The system is centered around three core ideas: a common shuffle layer customizable via templates, shuffle optimizations adaptive to workloads and networks, and a sampling mechanism that enables adaptation. Despite their simplicity, compute, combine, and shuffle can support use cases from graph processing (e.g., Pregel, Giraph) to SQL queries (e.g., SparkSQL and Hive). At its core, shuffle simply transfers data across nodes. The source/destination, transfer rate, and mode of synchrony can vary between systems, but in every case, the interface is consistent. The system supports this design by enabling a cleaner layering between applications and infrastructure. Rather than spend time tuning each application, users of the system template the shuffle layer that is common to all upper-layer systems by using customizable shuffle templates as a common layer. The system also provides adaptive shuffling. The system can take into account the workload, combiner logic, shuffle pattern of the application, and network topology to adapt the shuffle to the environment. At runtime, the system instantiates at least one shuffle plan to execute the shuffle and directs the shuffle data for higher layers. The system can operate as a service that large data platforms can invoke. System 200 provides shuffles to dynamically adapt to the query workload and network by sampling data that most efficiently tests the efficacy of optimizations. The application-centric sampling avoids classic constraints that come with the statistical estimation of population parameters such as knowing the distribution. Testing a small fraction of the data (as low as 0.01% in real-world workloads) already leads to high accuracy.

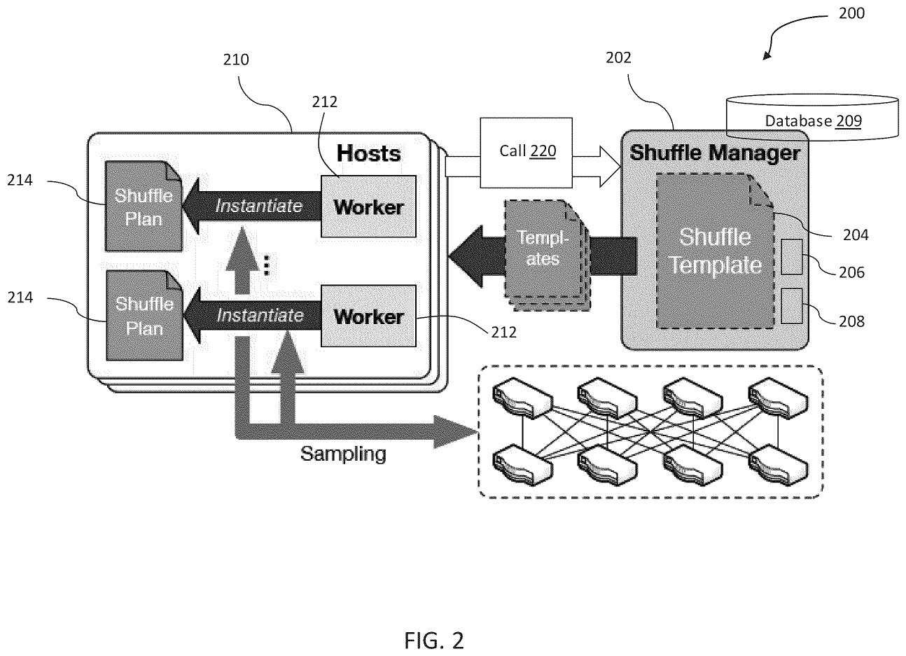

FIG. 2 is a block diagram of an example system 200 for providing shuffle templates and using the shuffle templates to implement shuffling of data among workers comprising compute resources in a data center. System 200 includes a shuffle manager 202 configured for providing an application programming interface (API). Shuffle manager 202 may include a computing device, for example and without limitation, a microcontroller, microprocessor, digital signal processor (DSP) and/or system on a chip (SoC) as described herein. Shuffle manager 202 may include a single computing device operating independently, or may include two or more computing devices operating in concert, in parallel, sequentially or the like; two or more computing devices may be included together in a single computing device or in two or more computing devices. Shuffle manager 202 includes at least one hardware processor 206 and memory 208 storing instructions for the processor 206. Shuffle manager 202, using processor 206 and memory 208, may be configured to perform any of the steps described herein. Shuffle manager 202 can include a database 209 from which the shuffle manager 202 can store, access, edit, and retrieve information. Database 209 can include at least one cloud drive.

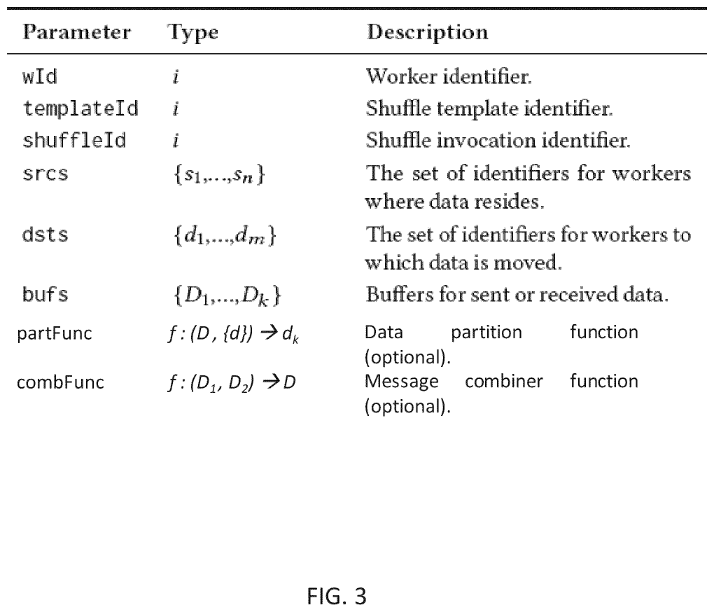

Using the API, applications can select shuffle templates 204 and specify data to be processed by workers 212 in a data center 210 using the shuffle templates 204 to distribute the data as messages transmitted among the workers 212. Shuffle manager 202 can store shuffle templates 204 in memory 208 and/or database 209. The API can include a shuffle call API through which applications can call 220 at least one shuffle template 204 specify a worker identifier, a template identifier, the shuffle template identifier, a shuffle invocation identifier, the source and destination identifiers, and buffers for sent or received data, as shown in FIG. 3. Call 220 for shuffle template 204 can include a remote procedure call (RPC).

Shuffle manager 202 can be deployed as a service by the infrastructure provider along with shuffle templates 204. During job execution, the application invokes the shuffle API, which results in the RPC to shuffle manager 202, and application workers 212 cooperate to instantiate shuffle template 204 to form a complete shuffle plan 214. Workers 212 execute shuffle plan 214 to shuffle their data.

FIG. 3 is a table of example parameters to shuffle call 220 (as shown in FIG. 2). The parameters in call 220 can include a worker identifier, shuffle template identifier, shuffle invocation identifier, a source identifier with a set of identifiers for workers where data resides, a destination identifier with a set of identifiers for workers to which data is moved, and buffers for sent and received data. In some aspects of the described subject matter, the above parameters can be required in call 220. Additional optional parameters can include a data partition function identifier and a message combiner function identifier.

Shuffle operations can be defined as instances of concurrent communication between a fixed set of sources and destinations. Programs invoke shuffles for a variety of reasons and in a variety of different contexts. These include loading data from network storage to workers, distributing intermediate values between iterations, and aggregating results. All of these uses can be specified using the following abstraction:
shuffle(wld, templateld, shuffleld,
   srcs, dsts, bufs, partFunc, combFunc)

In the base case, the RPC of a shuffle invocation (or call 220 as shown in FIG. 2) can require a worker identifier, a shuffle template identifier specifying which template to use, a shuffle identifier, a list of sources, and a list of destinations of the shuffle operation. For example, in Hadoop, the sources and destinations will be the list of Map and Reduce workers.

Other types of shuffles can be specified using optional parameters. For instance, communication patterns for reduction and aggregation can be implemented with a partition function. The function takes each piece of data and maps it to a destination worker. A simple example of a hash-based partition function (the default partition function) is the following:
partFunc(D, dsts):
   return hash(D) % dsts.size
      Finally, the shuffle call 220 can include a commutative and associative combiner function. For example, the combiner function for wordcount takes a set of (word, count) tuples and performs aggregation as follows:
combFunc((w, n1), (w, n2)):
   return (w, n1+n2)

System 200, as shown in FIG. 2, can be agnostic to the type of analytics job. Modifying existing code bases to run shuffling with system 200 is natural.

Referring again to FIG. 2, shuffle template 204 includes an algorithm for shuffling data, such as a large number of messages. The algorithm can include partitioning and/or combining messages. Shuffle template 204 can support a wide range of shuffle algorithms, for example and without limitation, an ordinary shuffle that sends messages from sources to destinations, a coordinated shuffle that pairs senders and receivers with two rotating rings to maximize bandwidth for a Non-Uniform Memory Access (NUMA) machine, a Bruck shuffle that schedules flows in an all-to-all pattern to avoid single process bottlenecks, a small level exchange that groups small shuffles to reduce cost in the cloud, a network-aware shuffling discussed herein, or a combination thereof. Shuffle template 204 can include parameters for workers 212 to process and transfer the data, such as parameters defining shuffle operations to perform on the data. The parameters can include a send parameter for sending a message to a destination, a receive parameter for returning data received from a source, and/or a fetch parameter for returning data fetched from a source. The parameters can include a partition parameter for partitioning messages according to a partition function and a combine parameter for combining message according to a combination function. The parameters can include a sample function for sampling messages based on a rate and partition function.

Shuffle manager 202 is configured to receive, via the API, a call for shuffle template 204. The call includes a shuffle template identifier for one of the shuffle templates and source and destination identifiers respectively identifying sources and destinations of data to be processed by the workers. A user may customize shuffle template 204 by, for example, selecting or combining one or more shuffle algorithms in shuffle template 204. Shuffle manager 202 selects shuffle template 204 identified by the call for the shuffle template 204 and provides the shuffle template 204 to workers 212. Shuffle manager 202 may store in memory 208 and/or database 209 the identifiers in the received call.

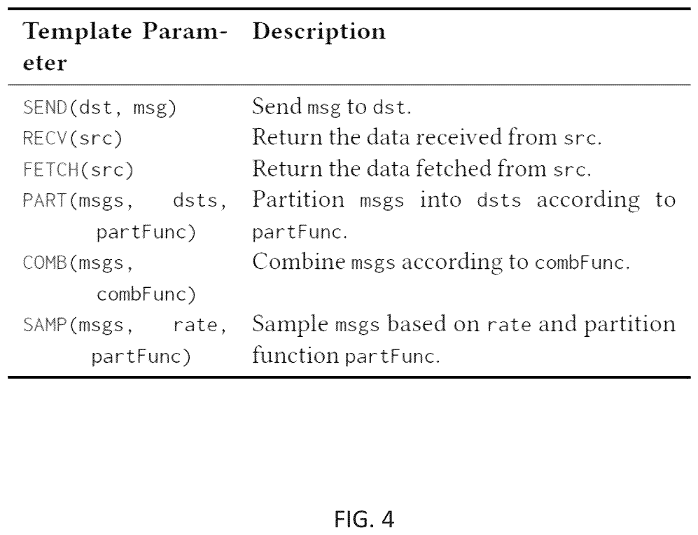

Data center 210, for example workers 212 of data center 210 comprising compute resources, may generate a shuffle plan 214 by defining at least one parameter in shuffle template 204 based on the identifiers in call 220. The result of shuffle calls are specialized shuffle plans that define the communication and processing to be done at each node to execute the larger shuffle operation. System operators do not define shuffle plans 214 directly but rather define Python-like shuffle templates 204 with parameters to be filled in, automatically, locally on workers 212 later. Workers 212 can use shuffle plan 214 to shuffle the messages among the workers 212 between the sources and the destinations. FIG. 4 is a table listing shuffle template parameters that are automatically instantiated when shuffle template 204 is received by workers 212, as shown in FIG. 2. Five of the shuffle template parameters act as primitives for basic communications (SEND, RECV and FETCH), data partition (PART), and message combine (COMB). Those primitives are easily translated to the language of each system. In addition, SAMP is the sampling function for estimating a particular shuffle cost. These parameters suffice to express a variety of shuffle algorithms including those in FIG. 4.

It is understood that these functions as well as the shuffle call 220 are synchronous, meaning that they run to completion in the invocation to ensure that the shuffle logic is executed and the data is delivered. Asynchronous communication to support overlapping computation and communication as future work can also be added in call 220 and shuffle template 204.

To support both pull, for example MapReduce systems, and push, for example Pregel-like systems, shuffle patterns, system 200 can separate the sender template and receiver template in a shuffle. SEND and RECV are designed for a push model where senders send messages, and FETCH is designed for a pull model where receivers proactively request messages. The pull-mode template for a simple “vanilla” shuffling where sources send messages to a list of destinations, such as in MapReduce, can be (sender template: call PART(bufs, dsts, partFunc) to partition messages; receiver template: for each n in srcs, call bufs[n]=FETCH(n) to fetch messages).

To support adaptive shuffle optimization, system 200 allows applications to sample messages. The SAMP function takes a set of messages msgs and sampling rate rate, performs partition-aware sampling (detailed in the next section) based on partFunc, and returns the sampled messages. Those samples can be used to run small, yet accurate, shuffle experiments to estimate parameters. The use of SAMP includes testing the efficiency of a particular shuffle and estimating the reduction ratio if a combiner is applied on a set of messages.

Shuffle manager 202 serves as a central controller to coordinate template instantiation and execution by workers 212. A primary functionality of shuffle manager 202 is to store and serve shuffle templates 204. System operators can first install optimized shuffle templates 204 according to their data center 210 network topology to shuffle manager 202. From an application's perspective, the shuffle API can resemble a big data execution model wherein individual workers will call the shuffle function described above. Senders and receivers can arrive at the shuffle at different times and the data can finish transferring to different destinations.

Specifically, when worker 212 invokes call 220, and if the requested shuffle template 204 is not cached locally, an RPC operation can be issued to shuffle manager 202 to request the shuffle template 204. Upon receiving an RPC request, shuffle manager 102 allocates a record in memory 208 for the request with necessary information, such as the worker identifier, the shuffle identifier, the template identifier, and current timestamp, to indicate the start of a shuffle at a particular worker. Then shuffle manager 202 sends shuffle template 204 back to worker 212. Once worker 212 receives the response from shuffle manager 202, the worker 212 continues by (1) populating shuffle template 204 with the arguments of the shuffle invocation, such as the parameters shown in FIG. 3, (2) compiling the shuffle template 204 into a physical shuffle plan 214, which is an executable for the system, e.g., a native library, (3) caching the shuffle template 204 and the shuffle plan 214 locally, and finally (4) executing the shuffle plan 214. Later invocations to the same template directly utilize the cached executable, with an asynchronous RPC request sent to shuffle manager 202 to record the shuffle.

When shuffle plan 214 is finished by worker 212, before shuffle returns, an RPC request indicating the completion of the shuffle can be sent to shuffle manager 202. Shuffle manager 202 can allocate another record to indicate the end of the shuffle. Shuffle manager 202 can leverage these records to track the progress of each worker 212 for a shuffle operation to handle stragglers or log the records to facilitate fault tolerance. Shuffle manager 202 can also be replicated and sharded for fault tolerance and scalability.

The parameterized shuffle templates 204 in system 200 can support a wide range of shuffle algorithms. We now describe several examples of optimized algorithms and show how they can be expressed in system 200. We focus on an optimization for data center 210 infrastructure, which we term network-aware shuffling, that can significantly improve shuffle performance. We further describe how SAMP ensures that our optimization never does worse than the baseline.

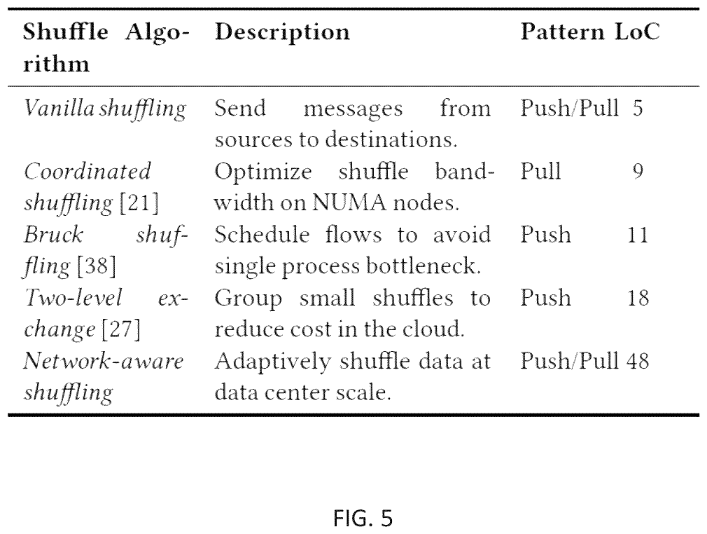

FIG. 5 is a table listing examples of shuffling algorithms and optimizations. LoC indicates the number of lines of template code for the corresponding algorithms. FIG. 5 lists three existing shuffle optimizations: coordinated shuffling, Bruck all-to-all shuffling, and two-level exchange that can be implemented using shuffle templates 204 (shown in FIG. 2). Coordinated shuffling pairs senders and receivers with two rings and rotates the rings clockwise to maximize the bandwidth for a NUMA machine; Bruck all-to-all shuffling schedules flows in an all-to-all pattern to make sure that the shuffle is never blocked in a single process; Two-level exchange optimizes data shuffling between serverless cloud functions. It reduces the complexity of all-to-all shuffle on file requests to the cloud storage (quadratic in the number of workers) by grouping workers so that the requests from the workers in the same group can be merged. These three optimizations can be implemented with 9, 11, 18 lines of shuffle template 204 code respectively. FIG. 5 includes for comparison a simple “vanilla” shuffling where sources send messages to a list of destinations, which can also be included in shuffling algorithms.

Referring again to FIG. 2, shuffle template 204 may control workers 212 to shuffle messages based on a topology of data center 210. For example, shuffle template 204 may include a network-aware shuffle algorithm that first instructs workers 212 to shuffle messages among the workers 212 within the same machine or server, then to shuffle among servers within the same rack at a server level, then to shuffle between the racks at a server level, and finally to shuffle at a global level. Network-aware shuffling optimizes for multi-layer data center 210 networks, starting from worker-level, then server-level, rack-level, and finally global shuffling. At each layer, it combines messages to reduce communication in the over-subscribed data center network, and it leverages sampling to control the potential overhead.

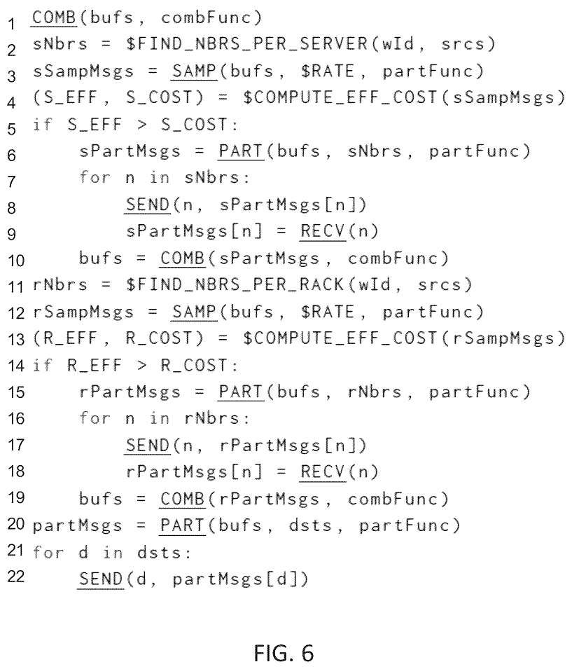

FIG. 6 shows an example network-aware shuffling template. FIG. 6 shows the sender template for this strategy in a leaf-spine data center topology, where servers are connected by ToR or ‘leaf’ switches, and leaves are then connected by a second layer of switches called the ‘spine’. This approach also applies to larger networks.

There are three potential stages to hierarchical shuffling in these types of networks. Before the shuffling begins, each worker, such as workers 212 in FIG. 2, performs a local combine operation to reduce the number of messages involved in the shuffling, as shown in line 1 of FIG. 6. The first stage is a server-local shuffle in which workers running on the same physical machine perform local shuffle and combine. Specifically, lines 2 finds the source workers that reside on the same server ($FIND_NBRS_PER_SERVER abbreviates the actual code). Line 3 calls SAMP to sample a $RATE of bufs, which is sSampMsgs, and then we run a shuffle between sNbrs on the sampled messages and applies combFunc to merge the shuffled messages to estimate the data reduction, based on which we estimate S_EFF, the time saved by the reduced data, and S_COST, the time of performing the server-level shuffle ($COMPUTE_EFF_COST abbreviates the actual code). Line 6 partitions the messages for the shuffle between sNbrs.partFunc denotes the partitioning function. Lines 7-9 shuffle the messages, and line 10 applies combFunc to merge messages and replaces bufs with new messages. By this step, all messages that have the same keys in the same server are guaranteed to be combined. This strategy significantly decreases network traffic when there is at least one co-located worker and the combiner is effective on the dataset.

The second step is done at a rack level (lines 11-19). Particularly for data centers with high degrees of over-subscription, inter-rack communication can be more costly than communication within a rack. In those situations, reducing the number of messages that are sent across racks can significantly speed up the communication and improve system performance. Finally, the normal global shuffle is performed with the remaining pre-combined data (lines 20-22). The receiver template simply receives data from sources as (for each n in srcs, call bufs[n]=RECV(n) to receive messages)).

Shuffle template 204 may be configured to test and compare the efficiency and cost of a shuffle, namely determine whether the time saved by reducing the data from the shuffle is greater than the time lost in performing the shuffle. Shuffle template 204 can include a sample function for sampling messages for testing the efficiency and cost of shuffle plan 214 shown in FIG. 2. Sampling may include partitioning the messages into groups based upon destinations of the messages, wherein messages for the same destination are in the same group and selecting messages from one of the groups.

Offsetting the performance benefits of hierarchical shuffling is the overhead of the local combination steps. Network-aware shuffling adaptively applies the local combines based on runtime decisions. It compares the efficiency and the cost (e.g., S_EFF and S_COST at server level). The actual shuffle is executed only if the efficiency is greater. We now describe how the sampling in SAMP works.

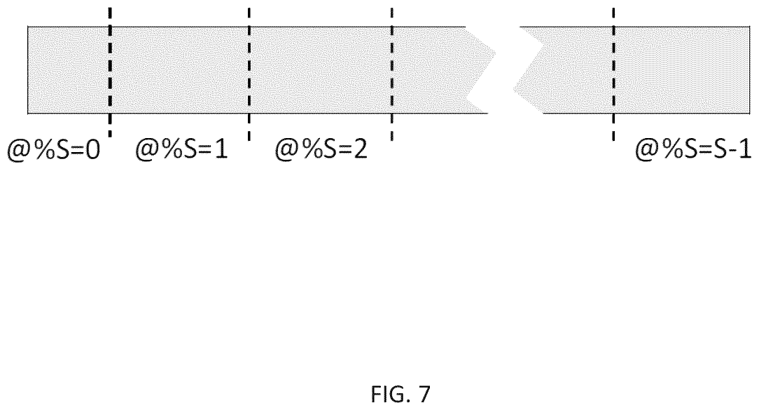

A naïve approach is to sample uniformly at random. Unfortunately, random sampling does not work well in practice, as described herein. Instead, system 200 can implement partition-aware sampling, which uses consistent hashing to sample the dataset more efficiently. To illustrate this technique, imagine a ‘letter count’ application that counts the frequency of letters (a-z) in a document. Rather than test a tuple-combiner on a random selection of tuples from random nodes (e.g., (h, 1), (v, 1), (z, 1), . . . ), a much more efficient method would be to sample the frequency of tuples by the letter (destination). More formally, we use a number S, derived from sampling rate, to divide the message destination space into groups from 0 to S−1. Each message on each worker is classified into the S groups using the shuffle's partitioning method so that messages for the same destination are in the same group. FIG. 7 shows a block diagram representing a partition-aware sampling, wherein @ denotes message destination. Finally, messages from a random group j are sampled by sending that group from each worker to a worker that acts as the sampling server for evaluation.

Sampling and testing may be implemented for each shuffle in shuffle template 204. For example, if shuffle template 204 includes the network-aware shuffle algorithm, the shuffle template 204 may control workers 212 to test the efficiency and cost of the shuffle within a machine or server, the server level shuffle, the rack level shuffle, and the global shuffle. Workers 212 can use results of the sampling to evaluate shuffle performance and implement shuffles in shuffle template 204 based on the results of the sampling.

The following describes an example test setup for the performance of system 200 (as shown in FIG. 2) and collected results. Our testbed has two racks of 10 servers with both the inter- and intra-rack bandwidths of 10 Gbps. Each server has an Intel E5-2660 CPU with 16 cores at 2.6 GHz, 128 GB RAM, a 10 Gbps network interface card, and 64-bit Ubuntu 16.04 OS. As a preliminary evaluation, we adopted an open-source version of Pregel to test the feasibility and efficiency of shuffle optimizations enabled by system 200. We use PageRank (PR), and single source shortest path (SSSP), over two real-world graphs with billions of edges: a web graph UK-Web (UK, 3.7B), and a social graph Friendster (FR, 3.6B). We evaluate system 200's sampling effectiveness, the benefits of network-aware shuffling, and its generality over network and workload variations.

The performance of system 200 depends critically on SAMP because high sampling rates can incur significant overhead to shuffle plan execution. Therefore, we first evaluate the accuracy and efficiency of system 200's sampling algorithm with duplication estimation, which then determines the data reduction rate.

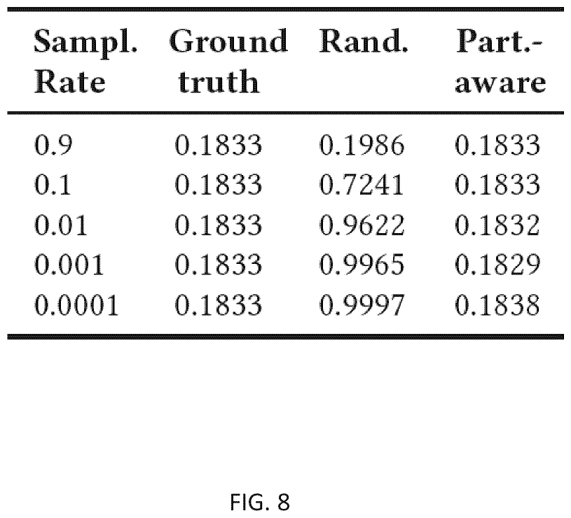

FIG. 8 shows a chart comparing the effectiveness of random sampling and partition-aware sampling for data reduction ratio estimation over a typical workload. Random sampling is close to the true ratio only when the sampling rate is as high as 90%. The overhead of this level of sampling overwhelms any potential improvements. By contrast, partition-aware sampling can achieve very high accuracy even when workers only send 0.01% of their messages for the sample run.

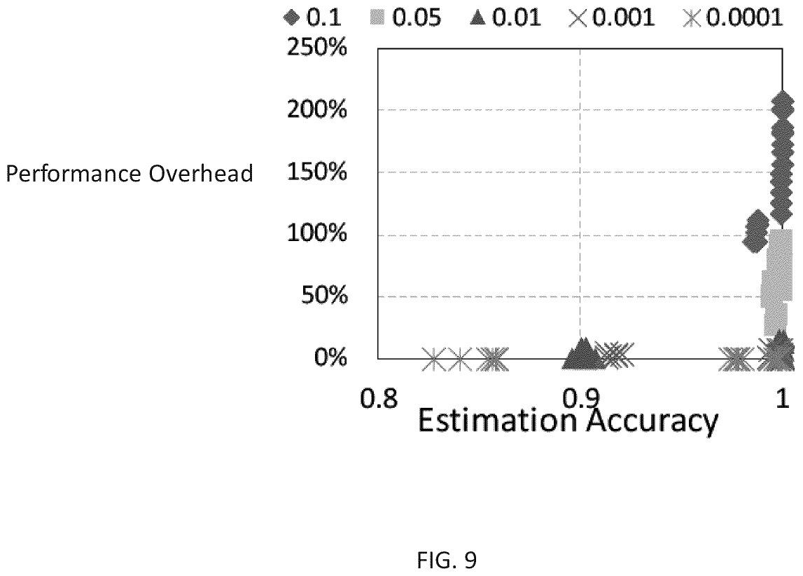

FIG. 9 shows the tradeoff between sampling accuracy and overhead for partition-aware sampling, where we vary the sampling rate (from 0.1 to 0.0001) across all applications and datasets. When sampling rate is larger than 5%, the overhead is large-a sampling rate of 10% causes 3× performance slowdown, prohibitively high in practice. As the sampling rate decreases, the overhead drops significantly. Partition-aware sampling achieves excellent accuracy. With a rate of 0.01%, the accuracy is still as high as 80%. Therefore, the rate we have used in the evaluations is between 1%-0.01%, which achieves 90%+ accuracy with only 8%− overhead. The SAMP procedure in system 200 is effective and efficient across scenarios.

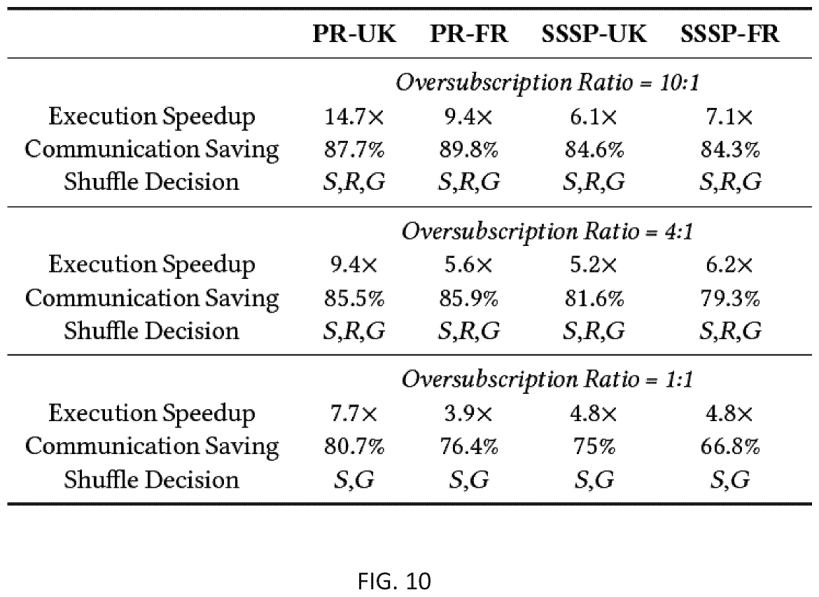

FIG. 10 is a table showing evaluations of oversubscription ratios in reference to server-level shuffle (S), rack-level shuffle (R), global shuffle (G), page rank (PR), single source shortest path (SSSP), UK web (UK), and Friendster (FR). FIG. 10 shows the execution time speedup achieved by network-aware shuffling across all workloads compared to vanilla shuffling baseline. We note that this optimization can directly benefit any system that is integrated with system 200, without repeated efforts on optimizing each system. We observe that when the network is highly oversubscribed (10:1, where inter-rack bandwidth is at a premium), network-aware shuffling can save 80%+ communication cost and achieve execution speedup from 6.1× to 14.7×. In less oversubscribed environments, it still reduces communication by 66.8-85.9%, and improves performance by 3.9-9.4×.

FIG. 10 also shows the shuffle strategies decided by network-aware shuffling according to its sampled runs. We observe that when the network is oversubscribed (e.g., 10:1 and 4:1), all three levels of shuffles are performed in the hierarchical shuffling: server level first, then rack level, and finally global shuffling (S, R, G in the table). In contrast, when the network is not oversubscribed (1:1), the rack-level shuffling introduces additional overhead. The best strategy is thus server-level, and then global shuffling. The accuracy of SAMP enables this detection, and network-aware shuffling chooses the optimal plan: S, G that achieves shorter completion times.

Robustness to network dynamics. We additionally evaluated network-aware shuffling with dynamic network scenarios. We injected three random link failures (between ToR and spine switches) for each scenario, and we emulated one hundred random failure scenarios. We observe that network-aware shuffling reduces completion times by 5×˜8.2×. In fact, with network-aware shuffling, the completion times under failure are very close to those without failures. This shows that network-aware shuffling can dynamically find better strategies and its benefit can be generalized to different network conditions.

Referring again to FIG. 2, system 200 can schedule individual shuffle invocations for each system or data center 210. This allows every system to optimize shuffles for their own performance based on the metrics of interest. However, when multiple systems or multiple instances of the same system use System 200 in the same cluster, global scheduling decisions can be important for both performance and fairness. For example, system 200 can identify co-flows between shuffle invocations. Scheduling such shuffles together can significantly improve the shuffling performance at application level. Co-scheduling the shuffle calls between multiple systems can also ensure the fair use of the network resources. Enabling flexible shuffle scheduling and identifying the right set of scheduling policies for a specific deployment are the main challenges.

System 200 currently can rely on upper-layer systems to identify failures and stragglers and to restart a shuffle operation. Handling failures of shuffle manager 202 can be readily resolved by replicating the management states and shuffle templates 204 installed on the shuffle manager 202. Handling failures of shuffles is challenging as the amounts of data involved in shuffles are often massive. Systems like Spark provide fault tolerance for shuffles by materializing the shuffled data into persistent files. These additional disk activities work fine for shuffles in traditional networks but incur high performance penalty for both large (bottlenecked by bandwidth) and small (bottlenecked by latency) shuffles in emerging fast data center networks. Providing fault-tolerant shuffles with minimal performance overhead for emerging and next-generation cloud networks and making them general for various shuffle templates are worth investigation. Handling stragglers is also challenging. It requires system 200 to have the abilities of tracking the progresses of all shuffle participants and restarting the tasks of a subset of the participants. The shuffle records in shuffle manager 202 can facilitate these tasks as discussed herein.

System 200 currently executes the compute and combine operations in CPUs. Recent years have witnessed many innovations on in-network processing, such as programmable data plane and SmartNICs. System 200 can use these techniques to enable new shuffle optimizations. For example, the COMB and SAMP functions can be pushed into the network to release the loads from host servers and to gain higher efficiency.

Data centers evolve fast. Shuffle optimizations that are effective for today's networks may not work for future data centers. For example, hierarchical shuffles for serverless functions that leverage a disaggregated storage backend will be unnecessary if functions can directly communicate. Recent trends on the design of cloud data centers indicate more radical changes. In particular, memory disaggregation separates the computation and main memory for data processing. It translates memory accesses into network communications. System 200 can implement developing shuffle templates for this new type of “shuffles” between disaggregated resource pools.

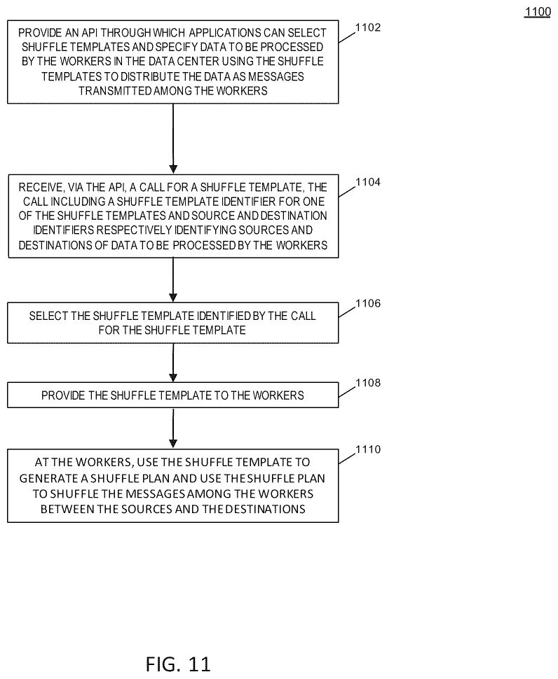

FIG. 11 is a flow diagram of an example method 1100 for providing shuffle templates. The method 1100 can be performed by a computer system having one or more hardware processors. At step 1102, the shuffle manager provides an application programming interface (API) through which applications can select shuffle templates and specify data to be processed by the workers in the data center using the shuffle templates to distribute the data as messages transmitted among the workers. Providing the API can include providing a shuffle call API through which applications can specify a worker identifier, a template identifier, the shuffle template identifier, a shuffle invocation identifier, the source and destination identifiers, and buffers for sent or received data.

At step 1104, the shuffle manager receives, via the API, a call for a shuffle template, the call including a shuffle template identifier for one of the shuffle templates and source and destination identifiers respectively identifying sources and destinations of data to be processed by the workers. the call for the shuffle template comprises a remote procedure call (RPC).

At step 1106, the shuffle manager selects the shuffle template identified by the call for the shuffle template. The shuffle template can include parameters for the workers to process and transfer the data. The parameters can define shuffle operations to perform on the data. The parameters can include a send parameter for sending a message to a destination, a receive parameter for returning data received from a source, and/or a fetch parameter for returning data fetched from a source. The parameters can include a partition parameter for partitioning messages according to a partition function and a combine parameter for combining message according to a combination function. The parameters can include a sample function for sampling messages based on a rate and partition function.

At step 1108, the shuffle manager provides the shuffle template to the workers.

At step 1110, the workers use the shuffle template to generate a shuffle plan and use the shuffle plan to shuffle the messages among the workers between the sources and the destinations. The workers can use the sample function to perform partition-aware sampling of the messages processed by different groups of workers in the data center. The workers can use results of the sampling to evaluate shuffle performance. The shuffle template can be configured to control the workers to shuffle the messages at a server level, then at a rack level, and a global level.

Although specific examples and features have been described above, these examples and features are not intended to limit the scope of the present disclosure, even where only a single example is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed in this specification (either explicitly or implicitly), or any generalization of features disclosed, whether or not such features or generalizations mitigate any or all of the problems described in this specification. Accordingly, new claims may be formulated during prosecution of this application (or an application claiming priority to this application) to any such combination of features. In particular, with reference to the appended claims, features from dependent claims may be combined with those of the independent claims and features from respective independent claims may be combined in any appropriate manner and not merely in the specific combinations enumerated in the appended claims.

The following references are incorporated by reference herein in their entirety:

### REFERENCES

[1] Joining and shuffling very large datasets using cloud dataflow. shorturl.at/belDY.
[2] Pregel+: A distributed graph computing framework with effective message reduction. http://www.cse.cuhk.edu.hk/pregelplus/.
[3] H. Abu-Libdeh, P. Costa, A. I. T. Rowstron, G. O'Shea, and A. Donnelly. Symbiotic routing in future data centers. SIGCOMM, 2010.
[4] M. Al-Fares, S. Radhakrishnan, B. Raghavan, N. Huang, and A. Vahdat. Hedera: dynamic flow scheduling for data center networks. NSDI, 2010.
[5] O. Alipourfard, H. H. Liu, J. Chen, S. Venkataraman, M. Yu, and M. Zhang. Cherrypick: Adaptively unearthing the best cloud configurations for big data analytics. Proc. NSDI, 2017.
[6] M. Alizadeh et al. CONGA: Distributed congestion-aware load balancing for datacenters. Proc. SIGCOMM, 2014.
[7] M. Armbrust et al. Spark SQL: relational data processing in spark. SIGMOD, 2015.
[8] S. Blanas, P. Koutris, and A. Sidiropoulos. Topology-aware parallel data processing: Models, algorithms and systems at scale. CIDR '20. www.cidrdb.org, 2020.
[9] P. Bodík et al. Surviving failures in bandwidth-constrained datacenters. Proc. SIGCOMM, 2012.
[10] M. Boehm et al. SystemmI: Declarative machine learning on spark. PVLDB, 9(13):1425-1436, 2016.
[11] P. Bosshart, D. Daly, G. Gibb, M. Izzard, N. McKeown, J. Rexford, C. Schlesinger, D. Talayco, A. Vahdat, G. Varghese, and D. Walker. P4: programming protocol-independent packet processors. Comput. Commun. Rev., 44(3):87-95, 2014.
[12] X. Cao, K. K. Panchputre, and D. H. Du. Accelerating data shuffling in mapreduce framework with a scale-up NUMA computing architecture. HPC '16.
[13] A. Ching et al. One trillion edges: Graph processing at facebook-scale. PVLDB, 8(12):1804-1815, 2015.
[14] M. Chowdhury and I. Stoica. Coflow: A networking abstraction for cluster applications. Proc. HotNets, 2012.
[15] P. Costa, A. Donnelly, A. Rowstron, and G. O'Shea. Camdoop: Exploiting in-network aggregation for big data applications. Proc. NSDI, 2012.
[16] J. Dean and S. Ghemawat. Mapreduce: Simplified data processing on large clusters. Proc. OSDI, 2004.
[17] P. Gill, N. Jain, and N. Nagappan. Understanding network failures in data centers: Measurement, analysis, and implications. Proc. SIGCOMM, 2011.
[18] J. E. Gonzalez, Y. Low, H. Gu, D. Bickson, and C. Guestrin. Powergraph: Distributed graph-parallel computation on natural graphs. OSDI, pages 17-30, 2012.
[19] J. E. Gonzalez, R. Xin, A. Dave, D. Crankshaw, M. J. Franklin, and I. Stoica. GraphX: Graph processing in a distributed dataflow framework. OSDI, 2014.
[20] B. Li, Y. Diao, and P. J. Shenoy. Supporting scalable analytics with latency constraints. PVLDB, 8(11):1166-1177, 2015.
[21] Y. Li, I. Pandis, R. Müller, V. Raman, and G. M. Lohman. Numa-aware algorithms: the case of data shuffling. CIDR′ 13.
[22] V. Liu, D. Halperin, A. Krishnamurthy, and T. Anderson. F10: A fault-tolerant engineered network. Proc. NSDI, 2013.
[23] Y. Lu, A. Shanbhag, A. Jindal, and S. Madden. Adaptdb: Adaptive partitioning for distributed joins. PVLDB, 10(5):589-600, 2017.
[24] G. Malewicz, M. H. Austern, A. J. C. Bik, J. C. Dehnert, I. Horn, N. Leiser, and G. Czajkowski. Pregel: a system for large-scale graph processing. SIGMOD 2010.
[25] O. Mashayekhi, H. Qu, C. Shah, and P. Levis. Execution templates: Caching control plane decisions for strong scaling of data analytics. ATC '17, 2017.
[26] Mellanox. Bluefield smartnic ethernet.
[27] I. Müller, R. Marroquin, and G. Alonso. Lambada: Interactive data analytics on cold data using serverless cloud infrastructure. D. Maier, R. Pottinger, A. Doan, W. Tan, A. Alawini, and H. Q. Ngo, editors, SIGMOD '20, pages 115-130.ACM, 2020.
[28] B. Nicolae, C. H. A. Costa, C. Misale, K. Katrinis, and Y. Park. Towards memory-optimized data shuffling patterns for big data analytics. CCGrid 2016.
[29] K. Ousterhout, C. Canel, S. Ratnasamy, and S. Shenker. Monotasks: Architecting for performance clarity in data analytics frameworks. Proc. SOSP, 2017.
[30] K. Ousterhout, C. Canel, M. Wole, S. Ratnasamy, and S. Shenker. Performance clarity as a first-class design principle. Proc. HotOS, 2017.
[31] K. Ousterhout, R. Rasti, S. Ratnasamy, S. Shenker, and B.-G. Chun. Making sense of performance in data analytics frameworks. Proc. NSDI, 2015.
[32] M. Perron, R. C. Fernandez, D. J. DeWitt, and S. Madden. Starling: A scalable query engine on cloud functions. D. Maier, R. Pottinger, A. Doan, W. Tan, A. Alawini, and H. Q. Ngo, editors, SIGMOD '20, pages 131-141. ACM, 2020.
[33] J. Perry and others. Fastpass: A centralized “zero-queue” datacenter network. SIGCOMM 2014, New York, NY, USA. ACM.
[34] Q. Pu, S. Venkataraman, and I. Stoica. Shuffling, fast and slow: Scalable analytics on serverless infrastructure. J. R. Lorch and M. Yu, editors, NSDI′ 19, pages 193-206. USENIX Association, 2019.
[35] Z. Qian, Y. He, C. Su, Z. Wu, H. Zhu, T. Zhang, L. Zhou, Y. Yu, and Z. Zhang. Timestream: Reliable stream computation in the cloud. Proc. EuroSys, 2013.
[36] A. Shkapsky et al. Big data analytics with datalog queries on spark. InSIGMOD2016.
[37] A. Singla, C.-Y. Hong, L. Popa, and P. B. Godfrey. Jellyfish: Networking data centers randomly. Proc. NSDI, 2012.
[38] R. Thakur, R. Rabenseifner, and W. Gropp. Optimization of collective communication operations in MPICH. IJHPCA, 19(1):49-66, 2005.
[39] L. Thostrup, J. Skrzypczak, M. Jasny, T. Ziegler, and C. Binnig. DFI: the data flow interface for high-speed networks. G. Li, Z. Li, S. Idreos, and D. Srivastava, editors, SIGMOD '21, pages 1825-1837. ACM, 2021.
[40] M. Tirmazi, R. B. Basat, J. Gao, and M. Yu. Cheetah: Accelerating database queries with switch pruning. In D. Maier, R. Pottinger, A. Doan, W. Tan, A. Alawini, and H. Q. Ngo, editors, SIGMOD '20, pages 2407-2422. ACM, 2020.
[41] M. Tork, L. Maudlej, and M. Silberstein. Lynx: A smartnic-driven acceleratorcentric architecture for network servers. J. R. Larus, L. Ceze, and K. Strauss, editors, ASPLOS '20, pages 117-131. ACM, 2020.
[42] A. Toshniwal, S. Taneja, A. Shukla, K. Ramasamy, J. M. Patel, S. Kulkarni, J. Jackson, K. Gade, M. Fu, J. Donham, N. Bhagat, S. Mittal, and D. Ryaboy. Storm@twitter. Proc. SIGMOD, 2014.
[43] M. Wawrzoniak, I. Müller, G. Alonso, and R. Bruno. Boxer: Data analytics on network-enabled serverless platforms. CIDR′ 21. www.cidrdb.org, 2021.
[44] Y. Xia and T. S. E. Ng. Flat-tree: A convertible data center network architecture from Clos to random graph. Proc. HotNets, 2016.
[45] Y. Xia, X. S. Sun, S. Dzinamarira, D. Wu, X. S. Huang, and T. S. E. Ng. A tale of two topologies: Exploring convertible data center network architectures with Flat-tree. Proc. SIGCOMM, 2017.
[46] M. Zaharia, T. Das, H. Li, T. Hunter, S. Shenker, and I. Stoica. Discretized streams: Fault-tolerant streaming computation at scale. Proc. SOSP, 2013.
[47] M. Zaharia et al. Resilient distributed datasets: A fault-tolerant abstraction for in-memory cluster computing. NSDI 2012.
[48] H. Zhang, B. Cho, E. Seyfe, A. Ching, and M. J. Freedman. Riffle: optimized shuffle service for large-scale data analytics. EuroSys 2018.
[49] Q. Zhang, A. Acharya, H. Chen, S. Arora, A. Chen, V. Liu, and B. T. Loo. Optimizing declarative graph queries at large scale. SIGMOD '19, pages 1411-1428, 2019.
[50] Q. Zhang, Y. Cai, S. Angel, V. Liu, A. Chen, and B. T. Loo. Rethinking data management systems for disaggregated data centers. CIDR '20. www.cidrdb.org, 2020.
[51] Q. Zhang, Y. Cai, X. Chen, S. Angel, A. Chen, V. Liu, and B. T. Loo. Understanding the effect of data center resource disaggregation on production dbmss. Proc. VLDB Endow., 13(9):1568-1581, 2020.
[52] Q. Zhang, H. Chen, D. Yan, J. Cheng, B. T. Loo, and P. V. Bangalore. Architectural implications on the performance and cost of graph analytics systems. Proceedings of SoCC, 2017, pages 40-51. ACM, 2017.

What is claimed is:

1. A method for providing shuffle templates and using the shuffle templates to implement shuffling of data among workers comprising compute resources in a data center, the method comprising:
providing, by a shuffle manager, an application programming interface (API) through which applications can select shuffle templates and specify data to be processed by the workers in the data center using the shuffle templates to distribute the data as messages transmitted among the workers;
receiving, by the shuffle manager and via the API, a call for a shuffle template, the call including a shuffle template identifier for one of the shuffle templates and source and destination identifiers respectively identifying sources and destinations of data to be processed by the workers;
selecting, by the shuffle manager, the shuffle template identified by the call for the shuffle template;
providing, by the shuffle manager, the shuffle template to the workers; and
at the workers, using the shuffle template to generate a shuffle plan and using the shuffle plan to shuffle the messages among the workers between the sources and the destinations.

2. The method of claim 1 wherein providing the API includes providing a shuffle call API through which applications can specify a worker identifier, a template identifier, the shuffle template identifier, a shuffle invocation identifier, the source and destination identifiers, and buffers for sent or received data.

3. The method of claim 1 wherein the shuffle template includes parameters for the workers to process and transfer the data.

4. The method of claim 3 wherein the parameters define shuffle operations to perform on the data.

5. The method of claim 4 wherein the parameters include a send parameter for sending a message to a destination, a receive parameter for returning data received from a source, and a fetch parameter for returning data fetched from a source.

6. The method of claim 4 wherein the parameters include a partition parameter for partitioning messages according to a partition function and a combine parameter for combining message according to a combination function.

7. The method of claim 4 wherein the parameters include a sample function for sampling messages based on a rate and partition function.

8. The method of claim 7 comprising using the sample function to perform partition-aware sampling of the messages processed by different groups of workers in the data center.

9. The method of claim 8 comprising using results of the sampling to evaluate shuffle performance.

10. The method of claim 4 wherein the call for the shuffle template comprises a remote procedure call (RPC).

11. The method of claim 1 wherein the shuffle template is configured to control the workers to shuffle the messages at a server level, then at a rack level, and a global level.

12. A system for providing shuffle templates and using the shuffle templates to implement shuffling of data among workers comprising compute resources in a data center, the system comprising:
a shuffle manager configured for:
providing an application programming interface (API) through which applications can select shuffle templates and specify data to be processed by the workers in the data center using the shuffle templates to distribute the data as messages transmitted among the workers;
receiving, via the API, a call for a shuffle template, the call including a shuffle template identifier for one of the shuffle templates and source and destination identifiers respectively identifying sources and destinations of data to be processed by the workers;
selecting the shuffle template identified by the call for the shuffle template; and
providing the shuffle template to the workers; and
workers configured for using the shuffle template to generate a shuffle plan and using the shuffle plan to shuffle the messages among the workers between the sources and the destinations.

13. The system of claim 12 wherein the API includes a shuffle call API through which applications can specify a worker identifier, a template identifier, the shuffle template identifier, a shuffle invocation identifier, the source and destination identifiers, and buffers for sent or received data.

14. The system of claim 12 wherein the shuffle template includes parameters for the workers to process and transfer the data.

15. The system of claim 14 wherein the parameters define shuffle operations to perform on the data.

16. The system of claim 15 wherein the parameters include a send parameter for sending a message to a destination, a receive parameter for returning data received from a source, and a fetch parameter for returning data fetched from a source.

17. The system of claim 15 wherein the parameters include a partition parameter for partitioning messages according to a partition function and a combine parameter for combining message according to a combination function.

18. The system of claim 15 wherein the parameters include a sample function for sampling messages based on a rate and partition function.

19. The system of claim 18 wherein the workers are configured for using the sample function to perform partition-aware sampling of the messages processed by different groups of workers in the data center.

20. The system of claim 19 wherein the workers are configured for using results of the sampling to evaluate shuffle performance.

21. The system of claim 15 wherein the call for the shuffle template comprises a remote procedure call (RPC).

22. The system of claim 12 wherein the shuffle template is configured to control the workers to shuffle the messages at a server level, then at a rack level, and a global level.

23. A non-transitory computer readable medium having stored thereon executable instructions that when executed by at least one processor of at least one computer cause the at least one computer to perform steps comprising:
providing an application programming interface (API) through which applications can select shuffle templates and specify data to be processed by workers in a data center using the shuffle templates to distribute the data as messages transmitted among the workers;
receiving, via the API, a call for a shuffle template, the call including a shuffle template identifier for one of the shuffle templates and source and destination identifiers respectively identifying sources and destinations of data to be processed by the workers;
selecting the shuffle template identified by the call for the shuffle template;
providing the shuffle template to the workers; and
using the shuffle template to generate a shuffle plan and using the shuffle plan to shuffle the messages among the workers between the sources and the destinations.

24. The non-transitory computer readable medium of claim 23 wherein providing the API includes providing a shuffle call API through which applications can specify a worker identifier, a template identifier, the shuffle template identifier, a shuffle invocation identifier, the source and destination identifiers, and buffers for sent or received data.
